(19) United States
(12) Patent Application Publication
(10) Pub. No.: US 2006/0184990 A1
(43) Pub. Date: Aug. 17, 2006

(54) Hybrid-fiber coaxial network-based high-speed QoS transmission system for internet protocol broadcasting service

(75) Inventors: Heung Sik Kwak, Sungnam (KR); Seoungsup Lee, Seoul (KR); Seong-Jun Bae, Seoul (KR)

Correspondence Address: STAAS & HALSEY LLP, SUITE 700, 1201 NEW YORK AVENUE, N.W., WASHINGTON, DC, 20005, US

(73) Assignees: HANAROTELECOM, INC., Seoul (KR); COMING MEDIA CO., LTD, Seoul (KR); NET&SYS CO., LTD, Seoul (KR)

(21) Appl. No.: 11/108,686

(22) Filed: Apr. 19, 2005

(30) Foreign Application Priority Data
Feb. 17, 2005 (KR) 10-2005-0013129

(51) Int. Cl. H04N 7/173

(52) U.S. Cl. 725/111; 725/129; 725/109

(57) ABSTRACT

Disclosed herein is a Hybrid Coaxial Fiber (HCF) network-based high-speed Quality of Service (QoS) transmission system for IP broadcasting service. In the system, a L3 switch unit, a CMTS and a coupler are provided on an ISP side, and an optical distributor, a cable modem, and IP set-top box are provided on an Internet service subscriber side. The transmission system includes one or more IP-QAM transmitters and an IP-QAM modem. The IP-QAM transmitters are connected between the L3 switch unit and coupler on the ISP side in parallel with the CMTS, and modulate the phases and amplitudes of IP broadcasting service data transmission signals into carrier signals different from Internet service data transmission signals and cable TV signals. The IP-QAM modem is connected to the coupler in parallel with the cable modem, and demodulates the IP broadcasting service data and transfer the demodulated IP broadcasting service data to the IP set-top box.

### BACKGROUND OF THE INVENTION

1. Field of the Invention

The present invention relates generally to a transmission system which can provide both Internet service and Internet broadcasting service using a cable television network and, more particularly, to a high-speed quality of service transmission system which can provide Internet service and IP broadcasting service using a hybrid-fiber coaxial network without interruption of traffic at low installation cost.

2. Description of the Related Art

Recently, Internet Service Providers (ISPs) using an existing cable Television (TV) network provide not only Internet service by connecting a Cable Modem Termination System (CMTS) and a cable modem to the cable TV network, but also Internet Protocol (IP) broadcasting service by connecting a set-top box to the cable modem on a subscriber side. Cable TV providers have used a Hybrid-Fiber Coaxial (HFC) network that incurs low installation cost, instead of an optical cable network that incurs high installation cost, as the cable TV network. Meanwhile, the ISPs using the cable TV network also uses the HFC network to provide Internet service.

FIG. 1 is a block diagram showing the construction of a conventional HFC network-based transmission system for IP broadcasting service, and FIG. 2 is a schematic graph showing the amount of data traffic in the IP broadcasting service using the transmission system shown in FIG. 1.

Referring to FIG. 1, an ISP 10 using a cable TV network provides Internet service by connecting a CMTS 13 and a cable modem 22 to an HFC 2, and IP broadcasting service by connecting an IP set-top box 26 to the cable modem 22 on an Internet service subscriber side 20, as described above.

In FIG. 1, a Dynamic Host Configuration Protocol (DHCP) server 11 and a Layer3 (L3) switch unit 12 are center equipment that ISPs use to provide Internet service. The DHCP server 11 functions to allocate IP addresses to users that use the Internet. The L3 switch unit 12 functions to select data for Internet subscribers from among a large amount of data that are transferred through the Internet and to transfer the Internet data to a corresponding CTMS 13.

The CMTS 13 functions to transfer the selected data to several hundreds or several thousands of cable modems 22 as radio wave signals for a wired or cable TV, receive Internet data request signals from subscriber computers 25, and manage the cable modems 22.

The conventional system for providing IP broadcasting service is a system in which the IP set-top box 26 is connected to the output side of the cable modem 22, and data are transferred through the CMTS 13 and the cable modem 22 to provide the broadcasting service of a video server 30 connected to the Internet. Accordingly, in the conventional IP broadcasting service system, the CMTS 13 and the cable modem 12, as shown in FIG. 1, must have high performance so that both Internet data and broadcasting service data are transferred, which is an important factor to determine the success or failure of broadcasting service. However, in the case in which an IP broadcasting service system is implemented using the CMTS 13 and the cable modem 22 that have high performance to the extent that several to several hundred broadcasting services are provided, a problem occurs in that either the investment cost increases sharply with the increase of screen resolution that determines the broadcasting quality of broadcasting service, or the screen resolution must be lowered below an appropriate level. In this case, since either excessive investment is required compared to an existing cable TV and satellite broadcasting service, or broadcast quality must be noticeably degraded, the conventional system shown in FIG. 1 is not suitable for the IP broadcasting service.

Furthermore, the conventional IP broadcasting system causes a serious transmission data traffic congestion problem.

As described above, in the existing IP broadcasting system, an IP set-top box 26 is connected to the cable modem 22 of Internet service provision equipment that is added to the cable TV network, and part of the data transmission capacity, which is provided by the CMTS 13 and the cable modem 22, is allocated to broadcasting service data transmitted between the video server 3 and the IP set-top box 26. In this case, the broadcasting service data provided from the video server 30 to the IP set-top box 26 are transferred through the same path as an existing Internet downstream data that are transferred via the L3 switch 12, the CMTS 13, the HFC network and the cable modem 22, so that a phenomenon in which the data transmission capacity provided by the CMTS 13 and the cable modem 22 is used for both the Internet service and the broadcasting service, occurs, which causes a traffic congestion problem. This problem is caused by transferring the IP broadcasting service data through a path identical to that of the Internet downstream data that are already provided by the CMTS 13 and the cable modem 22.

FIG. 2 is a schematic graph showing the amount of data traffic in the IP broadcasting service using the conventional transmission system. Both of the amount T_{IS} of Internet service data traffic indicated by a solid line and the amount T_{IPB} of broadcasting service data traffic indicated by a dotted line are shown in downstream data transmission capacity S_{down}. When the same path is shared by both the services, a moment at which an amount of data exceeding the downstream transmission capacity S_{down} exists occurs. At this moment, a phenomenon in which Internet service is excessively slowed or IP broadcasting service is interrupted occurs. In order to prevent the Internet service from being slowed or the IP broadcasting service from being interrupted, the use of the CMTS 13 and cable modem 22, which have very large downstream data transmission capacity S_{down}, may be considered. However, considering that several ten to several hundred types of broadcasting data are all provided in an IP broadcasting service in which single piece of broadcasting data has 2 Mbps, the problems cannot be solved merely by increasing the transmission capacity of the CMTS 13 and the cable modem 22.

### SUMMARY OF THE INVENTION

Accordingly, the present invention has been made keeping in mind the above problems occurring in the prior art, and an object of the present invention is to provide an HFC-based high-speed quality of Service (QoS) transmission system for IP broadcasting service, which is capable of transmitting high resolution broadcasting service data at low investment cost while using the CMTS and cable modem of a conventional internet service system for Internet service data.

Another object of the present invention is to provide an HFC-based high-speed QoS transmission system, which is capable of maintaining the uninterrupted flow of broadcast service data while not degrading the quality of the existing Internet service.

In order to accomplish the above object, the present invention provides an HCF network-based high-speed QoS transmission system for IP broadcasting service, in which a L3 switch unit, a CMTS and a coupler are provided on an ISP side, and an optical distributor, a cable modem, and IP set-top box are provided on an Internet service subscriber side connected to the ISP side through an HFC network, including one or more IP-Quadrature Amplification Modulator (IP-QAM) transmitters connected between the L3 switch unit and the coupler in parallel with the CMTS on the ISP side, the IP-QAM transmitters modulating the phases and amplitudes of IP broadcasting service data transmission signals, which are transmitted from the L3 switch unit into carrier signals having frequencies different from those of Internet service data transmission signals and cable TV signals and then transmitting the modulated carrier signals; and an IP-QAM modem connected to the coupler in parallel with the cable modem on the Internet service subscriber side, the IP-QAM modem demodulating the IP broadcasting service data transmitted from the IP-QAM transmitters, and transferring the demodulated IP broadcasting service data to the IP set-top box.

Preferably, the high-speed QoS transmission system further includes a switch unit between the cable and IP-QAM modems of the Internet service subscriber side to combine Ethernet data from the cable modem with Ethernet data from a the IP-QAM modem and to load the combined data onto a Local Area Network (LAN) that is connected to a computer and the IP set-top box.

The high-speed QoS transmission system further includes an IP-QAM management server on the ISP side to monitor the current operational status of the IP-QAM transmitter and to perform an emergency operation according to a predetermined scenario when an abrupt event occurs.

The IP-QAM management server functions to either create a broadcast program table for IP broadcasting service and a broadcast class number corresponding to a TV broadcast or receive them from a remote server, and to transfer Electrical Channel Information (ECI) to the IP-QAM modem located on the Internet service subscriber side.

Preferably, the IP-QAM modem stores the ECI that is created by the IP-QAM management server and is periodically transferred, and, when the IP set-top box requests an IP broadcasting service found from a video server, receives a transmission signal from the IP-QAM transmitter through which the requested IP broadcast service is provided, and provides the broadcast service requested by the IP set-top box through the LAN.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional HFC network-based QoS transmission system for IP broadcasting service;

FIG. 2 is a schematic graph showing the amount of data traffic in the IP broadcasting service using the transmission system shown in FIG. 1;

FIG. 3 is a block diagram showing an HFC network-based QoS transmission system for IP broadcasting service according to the present invention;

FIG. 4 is a schematic graph showing the amount of traffic of the IP broadcasting service data according to the present invention;

FIG. 5a to 5c are views showing the assignment of frequency bands in the cable TV to which the IP broadcasting service according to the present invention is added; and

FIG. 6 is a flowchart showing the IP broadcasting service using the transmission system according to the present invention.

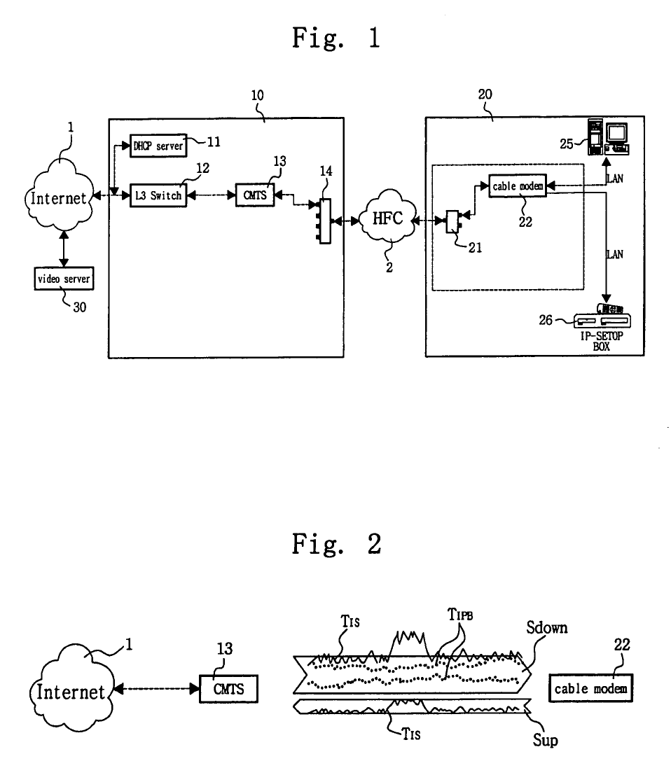

### DESCRIPTION OF THE PREFERRED EMBODIMENTS

An HFC network-based high-speed QoS transmission system according to the present invention is described in detail with reference to the accompanying drawings.

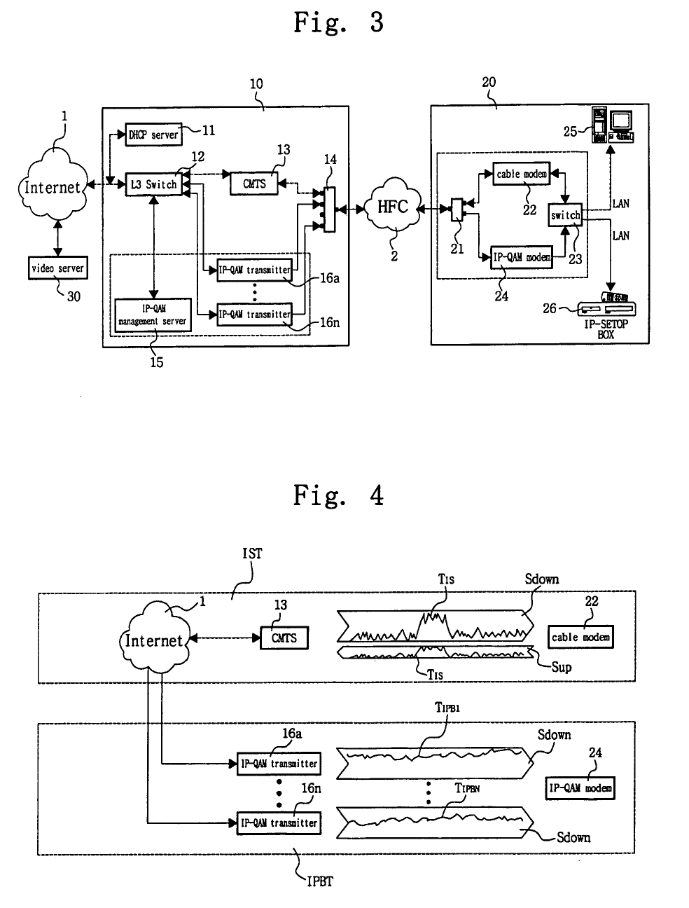

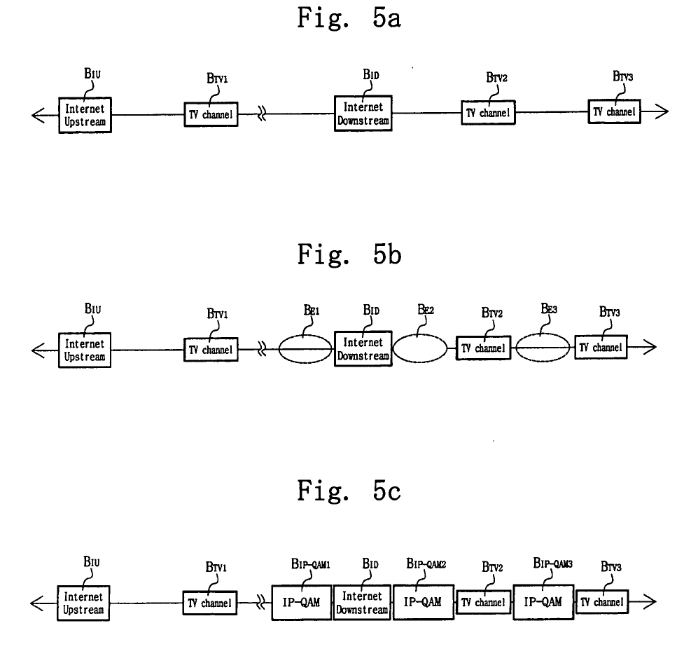

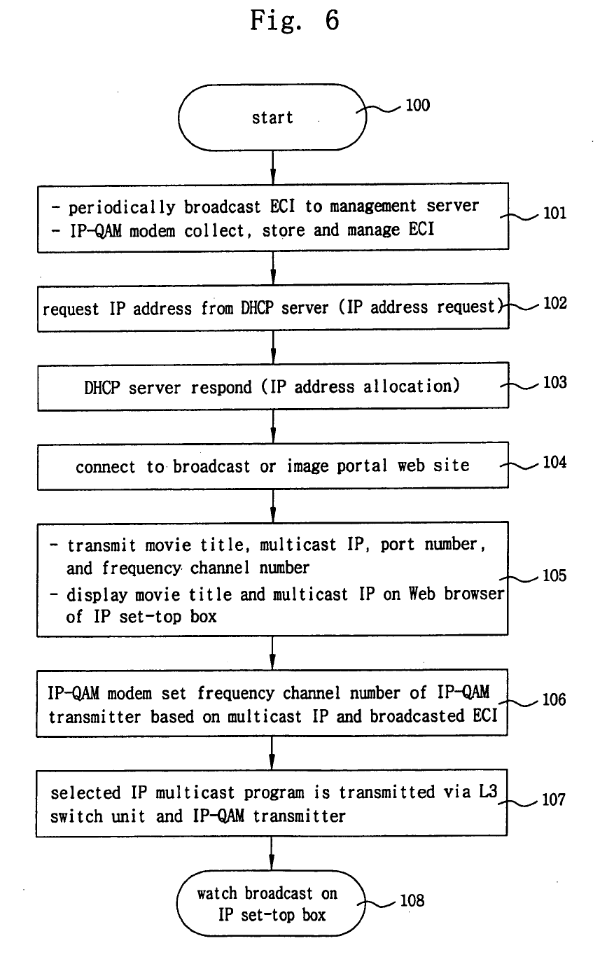

FIG. 3 is a block diagram showing an HFC network-based QoS transmission system for IP broadcasting service according to the present invention, FIG. 4 is a schematic graph showing the amount of traffic of the IP broadcasting service data according to the present invention, FIG. 5a to 5c are views showing the assignment of frequency bands in the cable TV to which the IP broad casting service according to the present invention is added, and FIG. 6 is a flowchart showing the IP broadcasting service using the transmission system according to the present invention.

Referring to FIG. 3, the present invention is characterized in that an ISP side 10 includes IP-QAM transmitters 16a, . . . , 16n, an Internet service subscriber side 20 includes an IP-QAM modem 24 corresponding to the IP-QAM transmitters 16a, . . . , 16n, Internet service data can be transmitted using a CMTS 13 and a cable modem 22, and IP broadcasting service data can be transmitted using the IP-QAM transmitters 16a, . . . , 16n and the IP-QAM modem 24.

That is, the high-speed QoS transmission system according to the present invention uses the CMTS 13 and cable modem 22 of the conventional transmission system to transmit the Internet service data, and uses separate data transmission devices, which are installed in parallel with the CMTS 13 and the cable modem 22, to transmit the IP broadcasting service data. For the IP broadcasting service, the IP-QAM transmitters 16a, . . . , 16n are connected to the L3 switch 12 of the ISP side 10 in parallel with the CMTS 13, and the IP broadcasting service data transmission signals of the IP-QAM transmitters 16a, . . . , 16n, together with Internet service data transmission signals, are loaded onto an HFC network 2 using a coupler 14, so that the IP-QAM modem 24, which is connected to the distributor 21 of the subscriber side 21 in parallel with the cable modem 22, can receive the IP broadcasting service data transmission signals. Accordingly, the path through which the Internet service data are transferred and the path through which the IP broadcasting service data are transferred are separate from each other, so that the phenomenon in which the Internet service is slowed or the IP broadcasting service is interrupted can be fundamentally prevented.

As shown in FIG. 3, the ISP side 10 includes a DHCP server 11, an L3 switch unit 12, a CMTS 13, a coupler 14, and IP-QAM transmitters 16a, . . . , 16n that are newly connected to a video server 30 for IP broadcasting service. The ISP side 10 may further include an IP-QAM management server 15 to manage the quality of IP broadcasting service. The Internet service subscriber side 20 includes the transmission signal distributor 21, the cable modem 22, the IP-QAM modem 24, the switch unit 23 for combining the output data of the cable modem 22 with the output data of the IP-QAM modem 24 and loading the combined data onto a Local Area Networks (LAN), and the set-top box 26 for receiving the broadcasting service data transferred from the video server 30, restoring the received broadcasting service data, and displaying them on a display device, such as a TV.

Like the conventional method, when the DHCP server 11, the L3 switch unit 12, the CMTS 13, and the cable modem 22 are ready for Internet service, the IP broadcasting service data transmitted from the video server 30 are output to a predetermined IP group of ports in a multicast manner. The L3 switch unit 12 transfers the data toward the IP-QAM transmitters 16a, . . . , 16n, not toward the CMTS 13. The transferred IP broadcasting service data are converted into carrier signals, the phases and amplitudes of which are modulated, in the IP-QAM transmitters 16a, . . . , 16n. The modulation frequencies of the IP-QAM transmitters 16a, . . . , 16n are different not only from the transmission signal frequency of the CMTS 13, but also from the frequency of the cable TV. Furthermore, in order to increase the number of IP broadcasting services, it is required to add and connect the IP-QAM transmitters 16a, . . . , 16n to be in parallel with one another as shown in FIG. 3, and to set modulation frequencies of the IP-QAM transmitters 16a, . . . , 16n to be different from one another. In this case, multicast type IP broadcasting service data are stably loaded onto the HFC network 2 by the dedicated IP-QAM transmitters 16a, . . . , 16n even when the data capacity of the CMTS 13 for Internet service is nearly saturated.

Referring to FIG. 4, it can be understood that the traffics T_{IPBI}, . . . , T_{IPBN} of the IP broadcasting service data exist in addition to the traffic T_{IS} of Internet service data. The Internet service data of the CMTS 13 and the IP broadcasting service data of the IP-QAM transmitters 16a, . . . , 16n are modulated into frequency bands different from each other, so that they can be stably transmitted without interfering with each other.

The fact becomes more apparent from the frequency arrangement of the transmission signals shown in FIGS. 5a to 5c. FIG. 5a shows an example of the arrangement of the frequency bands B_{TV1}, B_{TV2} and B_{TV3} of the cable TV radio wave signals of TV channels, the frequency band B_{ID} of Internet downstream signals transferred from the CMTS 13 to the cable modem 22, and the frequency band B_{IU} of Internet upstream signals transferred from the CMTS 13 to the cable modem 22, in an actual cable TV network. FIG. 5b shows frequency bands B_{E1}, B_{E2} and B_{E3} that are not used in FIG. 5a. The present invention uses the unused frequency bands B_{E1}, B_{E2} and B_{E3} as the modulation frequency bands B_{IP-QAM1}, B_{IP-QAM2} and B_{IP-QAM3} of the IP-QAM transmitters 16a, . . . , 16n, respectively, so that it can transmit the IP broadcasting service data without influencing the quality of existing TV channel signals and Internet service data signals.

Referring to FIG. 3 again, the IP-QAM management server 15 monitors the current operational status of the IP-QAM transmitters 16a, . . . , 16n, and performs an emergency operation according to a predetermined scenario if an abrupt event occurs. Furthermore, the IP-QAM management server 15 functions to either create a broadcast program table for IP broadcasting service and a broadcast class number corresponding to a TV broadcast channel or receives them from a remote server, and then transfer Electrical Channel Information (ECI) to the IP-QAM modem 24 on the Internet service subscriber side of the present invention and the IP set-top box 26 connected to the IP-QAM modem 24. It is preferred that the set-top box 26 installed on the service subscriber side be configured to connect to the video server 30 through a upstream data channel that is directed from the cable modem 22 to the CMTS 13, to check the type of IP broadcasting service and an IP broadcasting service subscription method, and to display results on a screen. The path of a service that is transmitted from the video server 30 is switched to the IP-QAM transmitters 16a, . . . , 16n using the L3 switch unit 12, so that the service can be provided to service subscribers through the IP set-top box 26.

In FIG. 3, the IP-QAM modem 24 of the Internet service subscriber side 20 functions to receive data transferred from the IP-QAM transmitters 16a, . . . , 16n and output the received data to the LAN. In this case, one of the IP-QAM transmitters 16a, . . . , and 16n, the output of which will be received, is determined by ECI type additional information provided from the IP-QAM management server 15. To this end, the IP-QAM modem 24 also functions to periodically store the number and types of IP-QAM transmitters 16a, . . . , and 16n, and the content of a charged IP broadcasting service. When the IP set-top box 24 requests IP broadcasting service found from the video server 30, the IP-QAM modem 24 receives the transmission signal of an IP-QAM transmitter 16a, . . . , or 16n through which the requested IP broadcasting service is provided, and outputs the requested IP broadcasting service to the IP set-top box 26 through the LAN.

In FIG. 3, the switch unit 23 functions to combine Ethernet data input to and output from the cable modem 22 with Ethernet data input to and output from the IP-QAM modem 24, and load the combined data onto the LAN.

FIG. 6 shows an example of an operation flow that starts from the periodic broadcasting of ECI by the IP-QAM management server 15 and ends in the reception of broadcasting service data by the IP set-top box 26.

Referring to FIG. 6, the HFC network-based high-speed QoS transmission system for IP broadcasting service according to the present invention performs the step 101 of the IP-QAM management server 15 periodically broadcasting ECI and the IP-QAM modem 24 collecting, storing and managing the ECI, the step 102 of the cable modem 22 requesting the IP address thereof from the DHCP server 11, the step 103 of the DHCP server 11 allocating the IP address to the cable modem 22, the step 104 of the IP-set-top box 16 connecting to a broadcast or image portal web site, the step 105 of the broadcast or portal web site transmitting a movie title, a multicast IP, a port number, and the frequency channel numbers of the IP-QAM transmitters 16a, . . . , 16n, and a web browser displaying the movie title and the multicast IP, the step 106 of the IP-QAM modem 24 setting the frequency channel numbers of the IP-QAM transmitters 16a, . . . , 16n based on the broadcasted ECI, and the step 107 of a set IP-multicast program being transmitted through the L3 switch unit 12 and the IP-QAM transmitter set at step 106. As a result, the user can watch the broadcast through the IP set-top box 26.

As described above, in accordance with the present invention, the HFC network-based high-speed QoS transmission system, which can transmit high resolution IP broadcasting service data without traffic interruption at low investment cost while not degrading the quality of service of the existing Internet network, can be implemented using the IP-QAM transmitters and the IP-QAM modem that are relatively low in price.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Hybrid Coaxial Fiber (HCF) network-based high-speed quality of Service (QoS) transmission system for Internet Protocol (IP) broadcasting service, in which a Layer3 (L3) switch unit, a Cable Modem Termination System (CMTS) and a coupler are provided on an Internet Service Provider (ISP) side, and an optical distributor, a cable modem, and IP set-top box are provided on an Internet service subscriber side connected to the ISP side through an HFC network, comprising:
one or more IP-Quadrature Amplification Modulator (IP-QAM) transmitters connected between the L3 switch unit and the coupler in parallel with the CMTS on the ISP side, the IP-QAM transmitters modulating phases and amplitudes of IP broadcasting service data transmission signals, which are transmitted from the L3 switch unit, into carrier signals having frequencies different from those of Internet service data transmission signals and cable TeleVision (TV) signals and then transmitting the modulated carrier signals; and
an IP-QAM modem connected to the coupler in parallel with the cable modem on the Internet service subscriber side, the IP-QAM modem demodulating the IP broadcasting service data transmitted from the IP-QAM transmitters, and transferring the demodulated IP broadcasting service data to the IP set-top box.

2. The high-speed QoS transmission system as set forth in claim 1, wherein the IP-QAM transmitters are arranged in parallel with one another, and have carrier frequency bands different from one another.

3. The high-speed QoS transmission system as set forth in claim 1 or 2, further comprising:
a switch unit located between the cable and IP-QAM modems of the Internet service subscriber side to combine Ethernet data from the cable modem with Ethernet data from the IP-QAM modem and to load the combined data onto a Local Area Network (LAN) connected to a computer and the IP set-top box.

4. The high-speed QoS transmission system as set forth in claim 1 or 2, further comprising:
an IP-QAM management server located on the ISP side to monitor current operational status of the IP-QAM transmitters, and to perform an emergency operation according to a predetermined scenario when an abrupt event occurs.

5. The high-speed QoS transmission system as set forth in claim 4, wherein the IP-QAM management server further functions to either create a broadcast program table for IP broadcasting service and a broadcast class number corresponding to a TV broadcast or receive them from a remote server, and to transfer Electrical Channel Information (ECI) to the IP-QAM modem located on the Internet service subscriber side.

6. The high-speed QoS transmission system as set forth in claim 5, wherein the IP-QAM modem stores the ECI that is created by the IP-QAM management server and is periodically transferred, and, when the IP set-top box requests an IP broadcasting service found from a video server, receives a transmission signal from the IP-QAM transmitter through which the requested IP broadcast service is provided, and provides the broadcast service requested by the IP set-top box through the LAN.
